(19) United States
(12) Patent Application Publication
(10) Pub. No.: US 2025/0248409 A1
(43) Pub. Date: Aug. 7, 2025

(54) METHOD OF MAKING TEA-BASED DOUGH FOR MANUFACTURING A FOOD PRODUCT AND TEA-BASED DOUGH MADE THEREFROM

(71) Applicant: Crimson Teas Inc., Toronto (CA)

(72) Inventor: Phillip CHAN, Toronto (CA)

(21) Appl. No.: 18/595,541

(22) Filed: Mar. 5, 2024

(30) Foreign Application Priority Data
Feb. 7, 2024 (CA) 3228496

(51) Int. Cl. A21D 2/36; A21D 13/066; A23L 7/109

(52) U.S. Cl. CPC A21D 2/36; A21D 13/066; A23L 7/109

(57) ABSTRACT

A method of making dough for manufacturing a food product, the method comprising: (i) providing brewed tea; (ii) providing flour; and (iii) mixing the brewed tea and flour to form a dough.

### FIELD OF THE INVENTION

The present invention relates to food products, namely, methods of making tea-based dough for manufacturing food products and tea-based dough made therefrom.

### BACKGROUND ART

Dough is a thick, malleable paste made from grains or from leguminous or chestnut crops. Once formed, dough can be used to make many different food products, such as but not limited to breads, biscuits, cakes, cookies, dumplings, flatbreads, noodles, pasta, pastry, pizza and piecrusts.

Dough can be made from a wide variety of flour, most commonly wheat and rye, but also maize, rice, legumes and almonds. A typical method of making dough is to mix the flour with water. Optionally, yeast or other leavening agents such as baking powder and baking soda can be included to help make the dough rise. The appeal of the food product can be enhanced with additional ingredients such as food colorings and flavor additives, either artificial or natural. Preservatives may also be used to extend the shelf life of the dough or food product.

Pasta and noodles are generally made by the following process:

1. Wheat flour is mixed with water, generally at or slightly above room temperature, often in a ratio of approximately 3:1. An industrial mixer can be used. Optional ingredients such as food colorings, flavor additives, preservatives, seasonings, egg and industrial alkaline can be added in this step. Industrial food grade alkaline is often added in noodle manufacturing to improve the chewiness of the noodle.

2. The mixture is then kneaded and blended to form a homogeneous dough.

3. The dough can be rolled out in a pasta/noodle machine or stretched/shaped by hand to form a sheet of desirable thickness.

4. This sheet is then passed through a cutter to form/portion the pasta/noodles. Alternatively, the dough is passed through an extrusion device that forms the desired shape/portion of the pasta/noodles.

5. Pasta and noodles may be cooked right after production, or they may be preserved for future use by refrigeration or drying/dehydration.

For breads, the process is generally different from pasta/noodles:

1. The dough is formed in a similar manner as described above.

2. Yeast or other leavening agents such as baking powder and baking soda can be added to help make the dough rise.

3. The dough is mixed, kneaded, and then allowed to rise.

4. Many bread doughs are then kneaded a second time, shaped into the final form, and left to rise a final time before baking.

Most flours contain two proteins called glutenin and gliadin. This includes flours containing the commonly used materials wheat, barley, rye and triticale. Glutenin gives the dough elasticity, while gliadin contributes extensibility to allow the dough to stretch. When water is added to these two proteins, they start forming bonds that link together, developing strands of gluten. As dough is mixed and kneaded, such as in the processes for making pastas, noodles and breads described above, more gluten is formed. The movement and agitation of mixing and kneading encourages the gluten strands to link up and form a network, which makes them stronger.

About 6% of the U.S. population is thought to be gluten intolerant. Another name for gluten intolerance is non-celiac gluten sensitivity (NCGS). A person has gluten intolerance when they get sick after eating gluten. Common symptoms include feeling tired, nauseous or bloated.

Celiac disease is less common than gluten intolerance, affecting about 1% of the population. It is the result of an abnormal gene. People with celiac disease have an autoimmune response to gluten. This reaction causes inflammation and damage to their digestive tracts.

Those with gluten intolerance or celiac disease need to restrict their diets to gluten-free food products that usually are made of non-wheat raw materials such as rice. Unfortunately, such materials are usually very low in or devoid of beneficial nutrients associated with wheat and rye. Gluten-free food products also often lack a pleasing texture. Also, materials such as rice have high glycemic load with an increased risk of diabetes, heart disease and some cancers.

Another drawback involves the above-mentioned addition of industrial food grade alkaline in the production of noodles. The alkalinity modifies the gluten into a helical, springy structure which gives the noodles a less desirable texture. The alkaline-treated noodles also tend to have a pungent, unpleasant taste.

It would be advantageous to offer food products made from dough which can be consumed by those with gluten intolerance and celiac disease. At the same time, such food products should have a desirable texture and taste, maintain a relatively high nutrient content, and should not substantially increase health risks such as from high glycemic load.

### SUMMARY OF THE INVENTION

In one aspect, the present invention provides a method of making dough for manufacturing a food product, the method comprising: (i) providing brewed tea; (ii) providing flour; and (iii) mixing the brewed tea and flour to form a dough.

In another aspect, the present invention provides a dough for manufacturing a food product, wherein the dough comprises a brewed tea and flour, wherein the brewed tea and flour are mixed together.

### Definitions

“Flour” refers to a powder obtained by grinding grain, such as wheat, and used for making food products such as pasta, noodles and bread.

“Dough” refers to a thick, malleable mixture of flour and liquid, used for making food products such as pasta, noodles and bread.

“Tea” refers to an aromatic beverage prepared by pouring hot or boiling water over cured or fresh leaves of Camellia sinensis, an evergreen shrub native to East Asia, or Camellia taliensis. Tea leaves may or may not be oxidized and/or fermented, either fully, partially or not at all.

“Oxidized” tea leaves refer to when the tea leaves are exposed to air (for oxidation) which tends to darken the colour of the tea.

“Fermented” tea leaves refers to when the tea leaves are subjected to a microbial process. For example, this may include adding a bacterial culture and moisture, to be mixed thoroughly into the harvested, sun-dried tea leaves.

“Black tea” refers to a type of tea produced from the leaves of the Camellia sinensis plant that are wilted, sometimes crushed, and fully oxidized, resulting in a darker hue.

“Green tea” refers to a type of tea produced from unwilted, unfermented and unoxidized leaves of the Camellia sinensis leaves.

“Pu-erh tea” refers to tea from the giant Carmellia sinensis leaf harvested in the mountain ranges in southern Yunan, China. Pu-erh tea leaf could be processed into a green tea, “raw” (naturally fermenting) tea, “ripe” (a technique developed that artificially accelerates fermenting/composting the tea leaf into a dark colour) tea, white (most tender, harvested prior to the chlorophyll can fully mature into a bright green colour) tea and black (fermented with a technique different from the “ripe” tea) tea.

“White tea” refers to a type of tea harvested before the leaf fully open and the chlorophyll could mature into a bright green colour and produced from wilted and unoxidized leaves of the Camellia sinensis leaves.

“Yellow tea” refers to a type of tea produced from unwilted and lightly oxidized leaves of the Camellia sinensis leaves that are allowed to yellow.

“Oolong tea” refers to a type of tea produced from wilted, bruised, partially fermented and partially oxidized leaves of the Camellia sinensis leaves

“Tannins (or tannoids)” are a class of astringent, polyphenolic biomolecules that bind to and precipitate proteins and various other organic compounds including amino acids and alkaloids.

“Tannic acid” is a specific form of tannin, a type of polyphenol. Its weak acidity (pKa around 6) is due to the numerous phenol groups in the structure.

### DETAILED DESCRIPTION OF PREFERRED EMBODIMENTS

The present invention provides a novel method of making dough for manufacturing a food product. The dough made from the method of the present invention can be used to make any food product that is generally made from dough, such as but not limited to breads, biscuits, cakes, cookies, dumplings, flatbreads, noodles, pasta, pastry, pizza and piecrusts. The food product is particularly suited for people with glucose intolerance or have celiac disease.

In a preferred aspect, the method comprises: (i) providing brewed tea; (ii) providing flour; and (iii) mixing the brewed tea and flour to form a dough.

The present invention includes the use of a wide range of teas in the formation of dough. Preferably, it may be black tea, green tea or a mixture of both. Also preferably, it may be other teas such as white tea, yellow tea, oolong tea, post-fermented/Pu′er tea and Matcha green tea, either alone or in combination with black tea, green tea or one or more of each other.

One preferred tea used in the present invention is the “gun-powder” styled, Pu-erh Green. Pu-erh is a name derived from the twin cities that have been the trading hub for the giant leaf of the sub-species of Camellia Senesis harvested in the nearby six mountain regions located along the Tropic of Cancer (that receives direct sun light year round). It is only in these regions in Yunnan, China, having high elevation with sharply contrasting day-night temperature, that Pu-erh tea leaves are found.

The Pu-erh tea leaf is generally processed in the four major steps of: (i) harvesting, (ii) withering, (iii) kneading; and (iv) dehydrated with about 15% moisture removed by exposure to direct sun-light. The gun-powder style is the result of a kneading technique of hand rolling to gently rupture the leaf skin and facilitate the release of tea flavour in the subsequent brewing process. The resulting tea leaves are called “raw” Pu-erh teas, wherein the tea leaves are alive and given reasonable temperature and moisture conditions, will ferment themselves slowly. Green Pu-erh is made by treating the freshly sun-dried raw Pu-erh with heat to further remove another 15% moisture content to inhibit the bio-ingredients from natural fermentation, thus the unfermented, green version of the Pu-erh. The major polyphenols in green tea are catechins, the pre-fermented version of theaflavins. Catechins are anti-oxidant and according to some research, help with preventing cancer and are also used in the prevention and treatment of conditions such as inflammatory bowel disease.

In another preferred embodiment, the flour is heated at about 200° F. for at least 30 minutes prior to mixing with the brewed tea. This step kills bacteria in the flour and reduces any raw taste in the flour.

The present invention includes the use of flour made from any grains normally used to make flour, such as but not limited to wheat, barley, rye, corn, oats, barley, millet and a combination of one or more of any of these.

It is preferred that the brewed tea and flour are mixed to form a dough with a hydration ratio of about 35%.

When mixing the brewed tea and flour, crumbs of dough are preferably formed. Preferably, the crumbs are pressed together to form one or more masses of dough. The dough can then be pressed into a sheet of dough.

When the food product is pasta or noodles, the sheet of dough is preferably passed through a cutter to form the pasta or noodles. Alternatively, the sheet of dough is passed through an extrusion device to form a desired shape of pasta or noodles.

The following is a description of preferred embodiments for manufacturing tea-based noodles in accordance with the present invention.

Preferably, Poleselli Soft™ wheat flour type “00” is used in this embodiment for manufacturing noodles. However, it is understood that many different types of flour may be used in the present invention, including flours containing other grains such as barley, rye, corn, oats, barley and millet. This particular flour is suitable for making any of noodles, pasta or bread products. It is a preferred flour for use in the present invention partly because it is a super fine wheat flour with a lower gluten content. The lower gluten content positively enhances the texture/chewiness of the products. No added enzymes or additives are present in this preferred flour.

### Black Tea-Based Noodles

1. The flour is pre-heated in an oven at about 200° F. (about 92° C.) for at least 30 minutes to kill off bacteria. This step also reduces any unpleasant raw taste from the flour. Pre-heating the flour also improves the production rate (aka Total Plate Count TPC), stability, quality and storage of fresh noodle, as well as giving a “positive” texture to the noodle. Further, this step partially pre-cooks the flour so that the final noodle product (which may be kept frozen until use) can be fully cooked (from frozen) in boiling water and ready to serve in as little as about two minutes.

2. Black tea is brewed preferably using Broken Orange Pekoe™ (larger grain) and/or Broken Orange Pekoe Dust™ (fine grain) which is a grade of black tea characterized by its fine grain of the leaf. About 30 g to 90 g of tea leaves are used per 3 liters of freshly boiled water. The black tea is brewed in an oven/warmer at about 200° F. (about 92° C.) for at least 20 minutes. It is understood that many other different types of black tea leaves can be used in the present invention.

3. The preheated flour is transferred to a commercial mixer, preferably in batches of approximately 2.5 kg. The size of each batch is determined by the capacity of the mixer as well as by maintaining a batch size that allows the resulting dough to dry out more easily. Optionally, salt can be added for flavouring.

4. The mixer is turned on and preferably operated on a low setting. The brewed black tea is added gradually until the mixture is just about to form crumbs. It can be added either as hot tea, room temperature tea or cold tea. The hydration ratio is maintained at the lower end, around 35%, such that the crumbs are just enough to form a mass that can be shaped by hands but not wet or sticky. In doing so, the final cut noodle threads are less likely to require any doses of dry flour to prevent them from sticking together.

5. The crumbs are gathered and hand-pressed into a large mass.

6. The mass is passed through a dough sheeting machine so that it is pressed into sheets. In a preferred embodiment, the dough sheet has a size of about 12 by 18 inches at a thickness of approximately ¼ inch.

7. The sheet is hand weighed and cut into 150 gram portions.

8. The portioned dough sheet is then passed through the noodle machine's press multiple times to be worked into a proper consistency and with a smooth edge.

9. The dough sheet is cut into threads of noodles. The diameter of the noodle threads is kept to approximately 1 mm in diameter.

10. The noodles may be cooked immediately, dried or frozen until use.

### Green Tea-Based Noodles

1. The flour is pre-heated in an oven at about 200° F. (about 92° C.) for at least 30 minutes to kill off bacteria. This step also reduces any unpleasant raw taste from the flour. Pre-heating the flour also improves the production rate (aka Total Plate Count TPC), stability, quality and storage of fresh noodle, as well as giving a “positive” texture to the noodle. Further, this step partially pre-cooks the flour so that the final noodle product (which may be kept frozen until use) can be fully cooked (from frozen) in boiling water and ready to serve in as little as about two minutes.

2. Pu-erh green tea is brewed preferably using about 20 g of Pu-erh gun-powder green tea per 1.25 liters of freshly boiled water. The tea is brewed in an oven/warmer about 200° F. (about 92° C.) for at least 10 minutes, preferably 15 to 20 minutes. It is understood that many other different types of green tea leaves can be used in the present invention.

3. The preheated flour is transferred to a commercial mixer, preferably in batches of approximately 2.5 kg. The size of each batch is determined by the capacity of the mixer as well as by maintaining a batch size that allows the resulting dough to dry out more easily. Optionally, salt can be added for flavouring. Also optionally, Japanese Matcha powder, preferably at an amount of about 20 g per Kg of flour may be added to enhance the flavour as well as the appearance with a bright green colour typical of Matcha.

4. The mixer is turned on and preferably operated on a low setting. The brewed green tea is added gradually until the mixture is just about to form crumbs. It can be added either as hot tea, room temperature tea or cold tea. The hydration ratio is maintained at the lower end, around 35%, such that the crumbs are just enough to form a mass that can be shaped by hands but not wet or sticky. In doing so, the final cut noodle threads are less likely to require any doses of dry flour to prevent them from sticking together.

5. The crumbs are gathered and hand-pressed into a large mass.

6. The mass is passed through a dough sheeting machine so that it is pressed into sheets. In a preferred embodiment, the dough sheet has a size of about 12 by 18 inches at a thickness of approximately ¼ inch.

7. The sheet is hand weighed and cut into 150 gram portions.

8. The portioned dough sheet is then passed through the noodle machine's press multiple times to be worked into a proper consistency and with a smooth edge.

9. The dough sheet is cut into threads of noodles. The diameter of the noodle threads is kept to approximately 1 mm in diameter.

10. The noodles may be cooked immediately, dried or frozen until use.

The present invention provides many advantages including but not limited to:

1. Teas comprise tannins (tannoids), including tannic acids, which form insoluble complexes with gluten. This renders the food product made from the present invention suitable for those who are glucose intolerant or have celiac disease.

2. The tannins in tea promotes an inhibitory effect which slows the digestion of starch. This greatly improves the glycemic response of the consumer which is important for diabetes management. As such, the present invention also makes the product suitable for those with diabetes and other conditions associated with high glycemic load.

3. There are further health benefits provided by tannins in the food product include anti-cancer, anti-inflammatory and anti-oxidation activity. For example, black tea contains theaflavins which are neuro-protective and lower the risk of Parkinson's Disease.

4. Food products made from the present invention using green tea include catechins, the pre-fermented version of theaflavins. Catechins are anti-oxidant and according to some research, help with preventing cancer and are also used in the prevention and treatment of conditions such as inflammatory bowel disease.

5. Food products made from the present invention using black tea that contains theaflavins protect nigral dopaminergic neurons against chronic MPTP/probenecid induced Parkinson's disease and have been associated with a reduced risk of Parkinson's Disease in epidemiology studies.

6. Teas have natural colors and aroma, which are pleasing to consumers. Therefore, the food product made through the present invention has a desirable taste to consumers.

7. The use of tea to form the dough improves the rheology and texture of the resulting food product.

8. The present invention allows for the use of any flour, even if the food product is to be consumed by people with gluten intolerance or celiac disease. This means that flours made from grains including wheat, barley, rye and triticale can be used, and the resulting food products maintain the high nutrient content of these grains.

The scope of the claims should not be limited by the preferred embodiments set forth in the examples, but should be given the broadest interpretation consistent with the description as a whole.

1. A method of making dough for manufacturing a food product, the method comprising:
(i) providing brewed tea;
(ii) providing flour; and
(iii) mixing the brewed tea and flour to form a dough.

2. The method of claim 1, wherein the brewed tea is selected from the group consisting of black tea, green tea, Pu-erh tea, white tea, yellow tea, oolong tea and a combination thereof.

3. The method of claim 1, wherein the flour is heated at about 200° F. for at least 30 minutes prior to mixing with the brewed tea.

4. The method of claim 1, wherein the flour is made from a grain selected from the group consisting of wheat, barley, rye, corn, oats, barley, millet and a combination thereof.

5. The method of claim 1, wherein the brewed tea and flour are mixed to form a dough with a hydration ratio of about 35%.

6. The method of claim 1, wherein the step (iii) of mixing the brewed tea and flour forms crumbs of dough, and further comprising a step of pressing the crumbs together to form one or more masses of dough.

7. The method claim 1, wherein the dough is pressed into a sheet of dough.

8. The method of claim 7, wherein the sheet of dough is passed through a cutter to form pasta or noodles.

9. The method of claim 7, wherein the sheet of dough is passed through an extrusion device to form a desired shape of pasta or noodles.

10. The method of claim 1, wherein the food product is for people with gluten intolerance or celiac disease.

11. A dough for manufacturing a food product, wherein the dough comprises a brewed tea and flour, wherein the brewed tea and flour are mixed together.

12. The dough of claim 11, wherein the brewed tea is selected from the group consisting of black tea, green tea, Pu-erh tea, white tea, yellow tea, oolong tea and a combination thereof.

13. The dough of claim 11, wherein the flour is made from a grain selected from the group consisting of wheat, barley, rye, corn, oats, barley, millet and a combination thereof.

14. The dough of claim 11, wherein the dough has a hydration ratio of about 35%.

15. The dough of claim 11, wherein the food product is for people with gluten intolerance or celiac disease.
